(19) United States
(12) Patent Application Publication
(10) Pub. No.: US 2025/0080459 A1
(43) Pub. Date: Mar. 6, 2025

(54) ROUTER WITH NETWORK VIRTUALIZATION AND CONFIGURATION

(71) Applicant: Techology, LLC, Lakewood, CO (US)

(72) Inventors: Ryan Calderon, Arvada, CO (US); John Young, Lakewood, CO (US)

(21) Appl. No.: 18/821,543

(22) Filed: Aug. 30, 2024

Related U.S. Application Data
(60) Provisional application No. 63/536,322, filed on Sep. 1, 2023.

(51) Int. Cl. H04L 45/741; H04L 43/50; H04L 45/76

(52) U.S. Cl. CPC H04L 45/741; H04L 43/50; H04L 45/76

(57) ABSTRACT

A router with network virtualization and configuration may be configured for a client site including a plurality of electronic devices. A configuration may be downloaded by the router, which then performs network configuration steps automatically including by identifying the plurality of devices at the client site and provisioning them according the LAN configuration. A user interface (UI) for configuring a network may include a router administrator dashboard for creating a detailed network configuration by assigning a plurality of ports of the router to the plurality of electronic devices in the selected network configuration, and sending the detailed network configuration to the router for use by the router in creating a network with the plurality of electronic devices at the client site.

### RELATED APPLICATION

This application claims priority to U.S. provisional patent application No. 63/536,322, filed Sep. 1, 2023, and incorporated herein by reference in its entirety.

### BACKGROUND

Increasingly, electronic devices are being developed with features that require network connectivity. These devices include smart appliances such as refrigerators, thermostats and garage door openers, as well as security cameras, lighting systems, and stereo systems, for example. A single home or other client site may include many of these devices that are distributed throughout the home. The creation of a network at the client site that provides connectivity between the devices and a wide area network (WAN) such as the Internet can be complex and challenging. In addition, the communication protocol used by each device may vary by manufacturer or type of device, making the creation of a network at the home or client site even more difficult.

Communications between a local area network (LAN) at a client site and a WAN is usually managed by a router. Routers typically have a user interface specific to the manufacturer. They require a knowledge of IP addresses, networking protocols and other technical details that may require a considerable amount of training and experience to install and maintain.

An integrator or network manager responsible for installing or maintaining a network at a client site may not be able to stay current with the ever expanding number of devices and protocols available.

### SUMMARY OF THE EMBODIMENTS

In a first aspect, a method, performed by a router at a client site including a plurality of electronic devices includes connecting to a wide area network (WAN), sending a serial number associated with the router to a server over the WAN, downloading a local area network (LAN) configuration for the plurality of electronic devices at the client site from the server, and identifying the plurality of devices at the client site and provisioning them according the LAN configuration.

In a second aspect, a computer-implemented method includes providing, for display on a computing device connected to a server, a user interface (UI) comprising a router administrator dashboard, receiving, via the UI, a user selection of a network configuration for a plurality of electronic devices at a client site, receiving, via the UI, a serial number of a router to be installed at the client site, creating, by the server, a detailed network configuration by assigning a plurality of ports of the router to the plurality of electronic devices in the selected network configuration, receiving, at the server, the serial number from the router when it is connected to the server, and sending the detailed network configuration to the router for use by the router in creating a network with the plurality of electronic devices at the client site.

In a third aspect, a system for performing any of the methods disclosed herein includes a master router and one or more child routers provisioned with configuration information by the master router, wherein the configuration information includes a service set identifier (SSID).

In a fourth aspect, a method, performed by a remote router registered with a router at a client site including a plurality of electronic devices includes connecting to a wide area network (WAN), downloading a local area network (LAN) configuration for the plurality of electronic devices at the client site from a server, and establishing a Virtual Private Network (VPN) to the router at the client site.

### BRIEF DESCRIPTION OF THE FIGURES

FIG. 1 is a schematic diagram of a network including a router with network visualization and configuration, in an embodiment.

FIG. 2 is a flowchart of a method of installing the router of FIG. 1, in an embodiment.

FIG. 3 is a flowchart of a method of repairing a LAN using the router of FIG. 1, in an embodiment.

FIG. 4 is a schematic diagram of the system of FIG. 1 including a virtual private network (VPN), in embodiments.

FIG. 5 is a flowchart of a method for remotely accessing a LAN with a VPN in the system of FIG. 4.

FIG. 6 is a flowchart of a method of conducting a speed test by a router with network virtualization and configuration, in embodiments.

FIG. 7 is a schematic diagram of a plurality of routers connected in a master-child configuration, in embodiments.

FIG. 8 is a flowchart of a method of simulating a client site network at a remote site using a travel router or a field router, in embodiments.

FIG. 9 is a schematic diagram of a secure VPN using a travel or field router using the method of FIG. 8, in embodiments.

FIG. 10 is a flowchart of a method of implementing firewall rules using a router with network virtualization and configuration, in embodiments.

### DETAILED DESCRIPTION OF THE EMBODIMENTS

In embodiments, a router with network virtualization and configuration may be used to automatically configure and deploy a local area network (LAN) connecting a plurality of electronic devices at a client site. As used herein, a LAN may be understood as a set of wired and/or wireless connections between a group of electronic devices in physical proximity to each other in a limited area. The limited area may encompass, for example, a residence, school, or office building, as well as a group of buildings forming a campus. A LAN typically uses a wireless communication protocol such as Wi-Fi® or a wired communication protocol such as Ethernet®, but other protocols may be used depending on the needs of the client. Any reference to LAN or transferring data between electronic devices using a LAN should be understood as encompassing both wired and wireless connections.

A LAN typically differs from a wide area network (WAN) in that the WAN extends over a large geographic area spanning regions, countries, or more. A WAN may transmit data over long distances and provide an interface between different networks. The Internet Protocol (IP) technology is typically used to transmit packets in a WAN.

Electronic devices at a client site may include smart televisions and appliances, mobile devices, tablets, laptops, and cable boxes, for example. Electronic devices, as used herein, may also include switches, access points, or Internet of Things (IoT) devices like doorbell cameras, thermostats, light bulbs, speaker systems and garage door openers. This list is not exhaustive; any device that may be connected to a network through other devices is contemplated.

A router is a networking device that connects a LAN to a WAN. The router includes a plurality of ports that may include both physical wired connections as well as wireless connections. Electronic devices at the client site are connected to a port so that the router can forward data traffic between the electronic devices and the WAN.

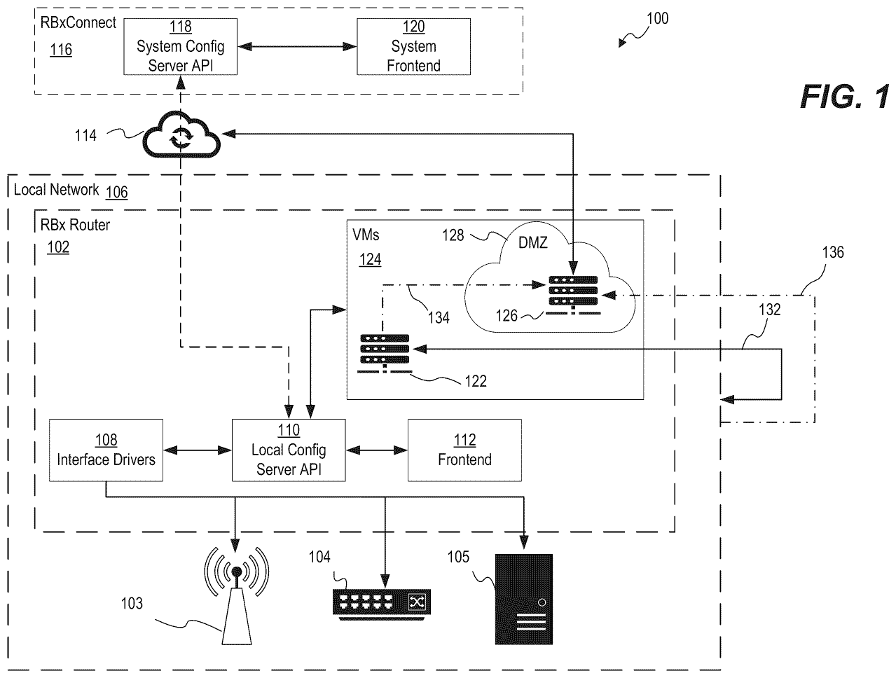

FIG. 1 is a schematic diagram of a system 100 including a router 102 with network visualization and configuration, in an embodiment. Router 102 communicates with electronic devices to form LAN 106. Electronic devices including access point 103, switch 104 and IoT device 105 as shown in FIG. 1 are for purposes of illustration only, other devices may be included in LAN 106. Router 102 communicates with devices 103, 104 and 105 using interface drivers 108.

The processing functions of router 102 are managed by Local Config Server 110. Server 110 communicates with frontend 112, which provides a user interface to a user who is managing router 102. Server 110 also connects to a WAN 114 such as the Internet to communicate with system server 116. System server 116 includes System Config Server 118 and system frontend 120, which provides a user interface for interacting with server 118. In embodiments, frontend 112 and system frontend 120 have a similar appearance so that router 102 may be accessed locally and remotely with the same interface and network configuration information.

In addition to managing data traffic between devices 103, 104, 105 and WAN 114, router 102 also provides network virtualization. Instead of adding a separate server as part of LAN 106, router 102 includes an internal private server 122 that may host one or more virtual machines (VMs) 124. A VM may include a private server 122 that is only accessed within LAN 106. This may be a file server or a public server 126 that is directly connected to WAN 114 such as a game server, for example. Router 102 manages two way communication between private server 122 and devices in LAN 106 as shown by solid line 132.

Public server 126 may be used in playing a specific video game such as Minecraft, where public server 126 interfaces between a video game player in LAN 106 and an outside server over WAN 114.

The direct connection between public server 126 and WAN 114 introduces security vulnerabilities into LAN 106. An unscrupulous party may be able to access and manipulate other devices in LAN 106 through public server 126. For this reason, most LANs that include a public server 126 host it in demilitarized zone (DMZ) 128. As shown in FIG. 1, DMZ 128 is provided within router 102, and provides one-way communication between game server 126 and private server 122 and devices 104 in LAN 106, as shown by dashed lines 134 and 136, respectively. A DMZ may also be referred to as a perimeter network or screened subnet.

The provision of DMZ 128 within router 102 provides a simpler network configuration and avoids the need for one or more separate firewall devices or a complex definition of ports and connections between servers and devices.

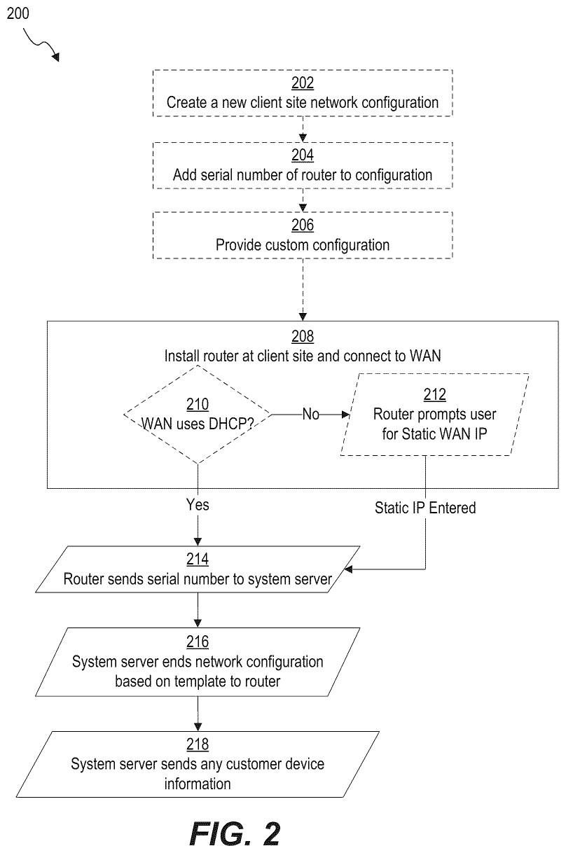

FIG. 2 is a flowchart of a method 200 of installing router 102 with network virtualization and configuration. Method 200 includes steps 208, 214, 216 and 218. In embodiments, method 200 also includes at least one of steps 202, 204, 206, 210 or 212.

Step 202 includes creating a new client site local area network (LAN) configuration. In an example of step 202, a user creates a configuration for LAN 106 for a plurality of devices 104 at a client site. A user may add identifying information for the client site, and select a configuration from a set of templates. In embodiments, templates may include both site level and device level templates that can be saved globally or for individual users. Some users may create identical setups for VLANs and wireless settings at each site, this would be the site level template, however each project usually has different switch and AP counts, models, and connection points, but usually within a site the devices tend to follow common configurations on them. A device may have templates, also, so that when a user is setting up the initial site setup (prior to deployment) they could add switches/access points and then select a template that would configure the ports and settings based on previous devices they have configured.

Step 204 includes adding a serial number of router 102 to the configuration. In an example of step 204, a router serial number is any number that uniquely identifies router 102 to system server 116.

Step 206 includes customizing the network configuration. In an example of step 206, a user may adjust elements of the network configuration template of step 202 by adding or subtracting quantities or types of devices 104, for example. The user may also add services to the configuration such as higher bandwidth or permissions such as firewall rules, explained in more detail below.

Step 208 includes installing router 102 at the client site and connecting it to WAN 114. In an example of step 208, router 102 associated with the serial number entered in step 204 is connected to a power source and to WAN 114. Connecting to WAN 114 may include connecting to a cable modem, a digital subscriber line (DSL) modem or an optical network unit (ONU), for example, depending on what type of Internet service is available at the client site.

Steps 210 and 212 include further steps of connecting router 102 to WAN 114. In step 210, if WAN 114 uses the Dynamic Host Configuration Protocol (DHCP) for network management, an IP address is automatically assigned to router 102. If not, in step 212, router 102 prompts a user to enter a static WAN IP address. These methods of connecting router 102 to WAN 114 are representative for purposes of illustrating embodiments disclosed herein, and other methods may be used.

Step 214 includes router 102 sending its associated serial number to system server 116. In an example of step 214, router 102 includes a unique identification number that is associated with the client site network configuration of step 202. After sending the serial number, router 102 waits for further instructions.

Step 216 includes sending the LAN configuration to router 102. In an example of step 216, router 102 downloads the assigned LAN configuration from system server 116. In a further example of step 216, router 102 may upload a configuration file.

Step 218 includes identifying the plurality of devices 104 at the client site and provisioning them according the LAN 106 configuration. In an example of step 218, router 102 receives any of the following information based on dealers default and manually configured items: VLANS, LAN IP addresses, subnet sizes, DHCP server settings (Range and reservations), custom DNS settings (Server Address and static hosts), WLAN configurations, listing of devices to provision (MAC, IP, username, password, type, port configurations, POE settings), custom routes, VPN client and server configurations. Router 102 connects with the devices 104 in the downloaded configuration and provisions them automatically with all settings needed to allow them to function in LAN 106 and interact with other devices over WAN 114 as needed. Router 102 enables devices (switches, access points, etc.) that were not necessarily built for automatic deployment to be deployed as if they were.

As disclosed herein, a LAN may be installed at a client site by plugging in a router and connecting it to a WAN or Internet service. The user at the client site does not need to know how to open ports, make any firewall concessions, or set up security. The user also does not set up a local interface then connect it to the Internet. Instead, as soon as router 102 is plugged in, there is one unified interface. In embodiments, the user does not manually configure router 102 for remote access.

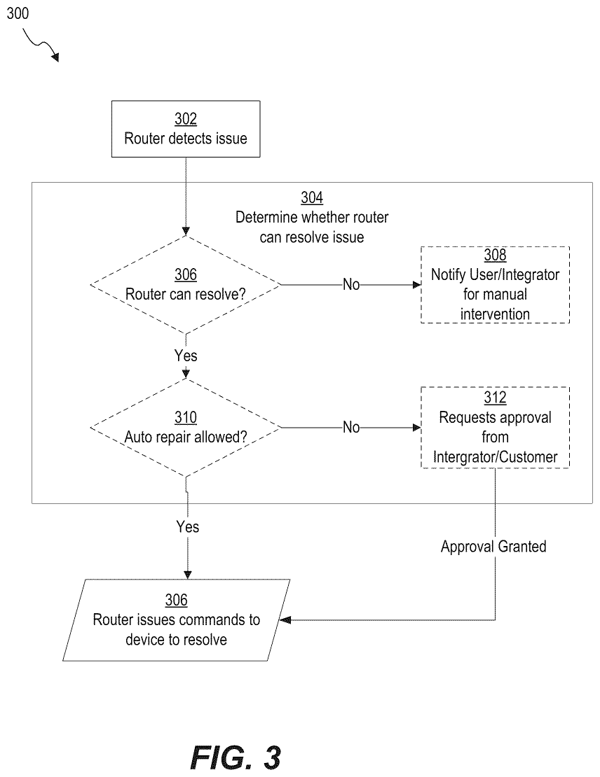

FIG. 3 is a flowchart of a method 300 of repairing a LAN configuration using router 102. Method 300 includes steps 302, 304 and 306. In embodiments, method 300 also includes at least one of steps 306, 308, 310 or 312.

Step 302 includes detecting, by router 102, an issue of concern in LAN 106. In an example of step 302, this may include a missing or changed connection between two of devices 104 or between a device 104 and router 102. Detecting an issue may also include detecting that one or more of devices 104 has physically connected to a different port in the LAN configuration maintained by router 102. It may also include detecting that a first device 104 has blocked a port used by a second device 104. Further, detecting an issue may include detecting that a switch or access point has been replaced, requiring that one or more of devices 104 need to be reconnected to the new switch or access point. Other connection problems may include devices being offline, devices changing status (slower speed, or even different VLAN), clients flapping (connecting, disconnecting, over and over again in short succession), POE (Power over Ethernet) being supplied with no active device on the port and switch errors that are not normally detected, like MTU (maximum transmission unit) rate changes.

Step 304 includes determining whether router 102 can resolve the issue detected in step 302. Step 306 includes determining whether the issue is within the capability of router 102 to solve. If not, a message may be sent to a client or network manager at step 308 with an alert that there is a network problem. If router 102 can resolve the issue, a further determination in step 310 may be made as to whether router 102 has permission to automatically repair the issue. If not, approval may be requested from a user or network manager in step 312. If automatic repair is allowed or approval is given, the method proceeds to step 306.

In step 306, router 102 issuing commands to the one or more electronic devices to resolve the connection problem. In an example of step 306, this may include changing the LAN configuration to reflect the changed physical connections, issuing commands to an electronic device to switch to another port or changing the protocols or provisioning of one or more electronic devices.

A representative set of steps is shown in FIG. 3, however, these steps may be performed in a different order, some steps may not be performed or additional steps may be added. For example, steps 306 and 310 may be reversed, they may be combined with one message with multiple options listed, or messages may be sent to both a client and a user responsible for maintaining LAN 106.

### Example 1

After LAN 106 has been deployed and configured by router 102, a service person may install a sprinkler system at a client site that uses a wired controller where the sprinkler system must be physically plugged into router 102 or an access point. In some instances, the service person is not able to connect a controller cable to a correct port so unplugs a cable from a first port, moves it to a second port, then plugs the controller cable into the first port. This may cause a connection problem for the cable originally plugged into the first port, which may be driving a DVR system security cameras or a lighting system, for example.

### Example 2

LAN 106 may include one or more switches that interconnect multiple devices. Replacing this switch requires disconnecting a plurality of cables, then reconnecting them to the new switch. Depending on how many cables are plugged into the switch, returning the correct cable to the correct port may cause a network topology problem. Router 102 may use it's knowledge of the network configuration of LAN 106 to adjust the assigned ports without requiring physically moving cables at the switch.

### Example 3

Wireless home sound systems, such as those provided by Sonos®, may use a proprietary communication protocol to establish connections between their speakers and/or their other devices at the client device. Some of these systems provide three types of connection: Ethernet, regular Wi-Fi®, and a propriety wireless protocol, which is a separate wireless connection linking all their devices. The system may turn on all types of connections for each installed device then rely on Spanning Tree Protocol (STP) or Rapid STP (RSTP) to maintain connections and detect the correct path back to the switch. Since it is a proprietary system, it may not use standardized RSTP or STP parameters and therefore, it may cause problems with other switches in LAN 106. These problems may include blocking other ports, like a downlink switch or the switch that powers the Wi-Fi®. Router 102 can interact with the system and turn off wi-fi for the devices that don't need it. It can also provision the switch ports for those devices manually to keep them from causing connection problems for other devices. Many of these sound systems don't have remote configuration capabilities, a user has to be onsite to set up and maintain the system. However, router 102 can provide a remote access feature for a wireless home sound or similar systems.

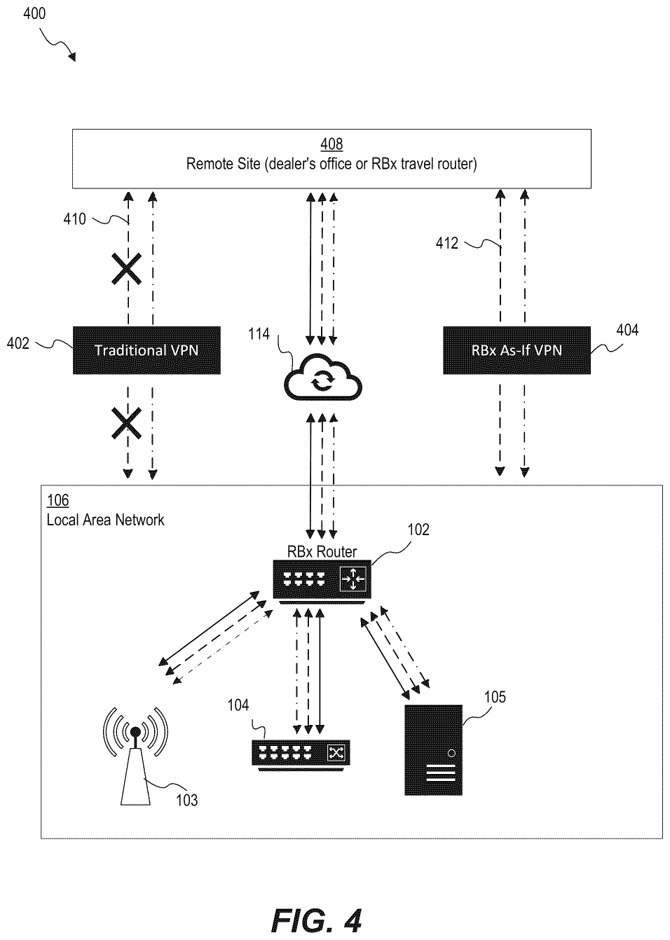

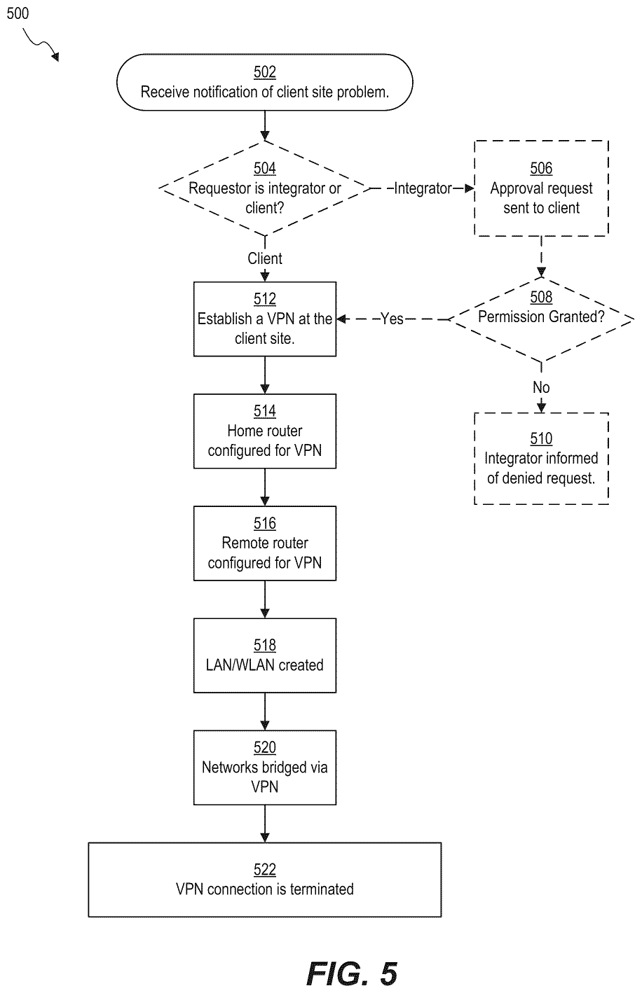

FIG. 4 is a schematic diagram of a system 400 including a virtual private network (VPN). FIG. 5 is a flowchart for remotely accessing a LAN with a VPN as shown in FIG. 4. FIGS. 4 and 5 are best viewed together in the following discussion.

System 400 of FIG. 4 is an example of system 100 of FIG. 1 and illustrates the difference between a traditional VPN 402 and a layer 2 VPN 404 provided by router 102. LAN 106 and Internet 114 typically provide communication with devices 103, 104, 105 using multiple protocols. These may include Physical layer communications (solid lines), Layer 2 communications (MAC/Broadcast, dashed lines) and Layer 3 communications using IP (dash-dot lines). Some IoT devices in LAN 106 require layer 2 (Broadcast) traffic to be discoverable and connected to by a client's or network manager's device for either use or configuration. Some examples of this type of device are a Sonos® system or a Lutron® Radio RA2. In traditional VPN 402, layer 2 traffic is blocked as represented at 410 thus preventing remote configuration and troubleshooting of these types of IoT devices. Router 102 may include an emulated VPN 404 as a configuration method for creating a layer 2 bridge 412 between a client site with LAN 106 and remote site 408. This allows the client or integrator to create a dedicated WLAN or LAN that is bridged to the home site network, thus allowing any device connected to this newly created network to act as if it is on the physical network with devices at the home site. In embodiments, creating a network bridge may include assigning the specified port or wireless SSID to a selected VLAN/Network on the client site. The emulated VPN 404 allows Layer 2 traffic, SSDP and other discovery protocols, Multi and unicast traffic, as well as any other broadcast traffic to be sent/received between the client's site and the specified LAN port or wireless SSID.

FIG. 5 is a flowchart of a representative method 500 of configuring a VPN that emulates a physical connection/presence VPN connection to a client site. Method 500 includes steps 502 and 512-522. In embodiments, method 500 also includes steps 504-510.

Step 502 includes a network manager receiving a notification that there is a problem at a client site, such as the client reporting that their lights aren't working (Luton).

Optional step 504 includes determining whether the remote access request is received from an integrator or directly from the client. If it is received from an integrator, an approval request may be sent to the client at step 506.

In step 508, it is determined whether or not the client gives approval for the network manager to connect remotely. If the client doesn't give approval, at step 510, the network manager informs the integrator of a denied request. At this point, the integrator may decide to take a different approach to resolving the client site problem, such as sending a truck to the client site.

At step 512, the network manager at a remote site can connect to the system 408 and establish a layer 2 VPN 404.

At step 514, router 102 at client site LAN 106 will be configured for VPN access. At step 516, a remote router will also be configured with a VPN. If the network integrator has a switch at their location, a laptop may be used at the remote site and provisioned as a virtual LAN (VLAN) unique for that purpose, otherwise connections may be made using a travel router or other similar device over a wireless network such as Wi-Fi™.

In step 518, a LAN/WLAN is created at the requestor's site.

In step 520, the LAN/WLAN created in step 518 will be bridged with the customers LAN 106 and provide the network manager with a wireless SSID or physical port on router 102. The network manager can plug into that port and appear to be connected to LAN 106 as if the network manager was physically at the client site. The layer 2 VPN 404 allows access to all devices at client site LAN 106 so the problem can be fixed remotely.

In step 522, the layer 2 VPN is terminated. In an example of step 522, the VPN will end automatically. Conditions that may cause the VPN to end include the expiration of a set time limit, the detection of excessive idle time, or a client revoking access to LAN 106, for example.

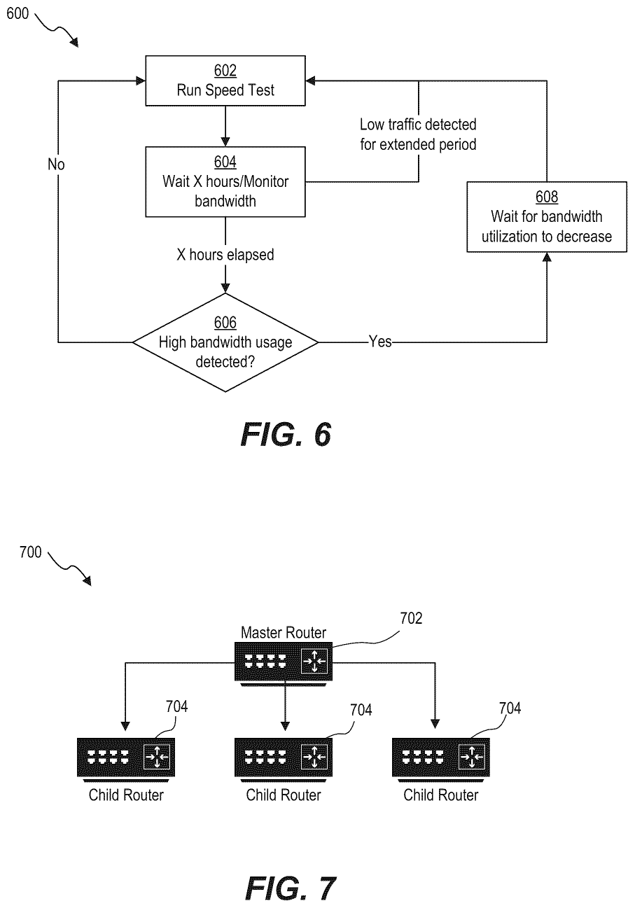

FIG. 6 is a flowchart of a method 600 of conducting a speed test by router 102 with network virtualization and configuration. Network devices may perform speed tests at regular intervals to gauge the health and connectivity of the network. In embodiments, router 102 performs intelligent interval based testing. This is in contrast to a regular interval speed test that may be occur when a device happens to be downloading or uploading a large file, thus giving a negative speed test result that does not reflect the actual performance of the network. Instead of performing a speed test at intervals of a number of hours or days, router 102 may adjust the timing of speed tests based on the momentary activities of devices 104 in LAN 106.

In step 602, router 102 performs a speed test. In an example of step 602, this speed test may be scheduled at a regular interval or triggered by an external request, such as client input or network behavior.

In step 604, based on the outcome of the speed test in step 602, router 102 may delay or reschedule the speed test as needed. This delay may be a fixed or variable number X hours, or may based on monitoring bandwidth usage by LAN 106. In a further example of step 604, router 102 may also detect a lack of activity on the network for an extended period of time and schedule more frequent speed tests.

In step 606, after X hours have elapsed, router 102 determines whether or not LAN 106 is still using high bandwidth. If yes, in step 608, router 102 waits for a further amount of time before returning to step 602 to run another speed test. If no, router 102 returns to step 602 to conduct another speed test.

FIG. 7 is a schematic diagram 700 of a plurality of routers connected in a master-child configuration. This type of configuration may be used, for example, in a multiple dwelling unit (MDU) environment such as an apartment building.

In embodiments, a client site may include a plurality of independent client sites, such as an apartment or condo building or complex of buildings. Instead of each unit arranging for service from an Internet Service Provider (ISP) individually, a management company may manage a network provided to all residents. In embodiments, such a network may include a core/master router 702 and a plurality of child routers 704. Master router 702 may have a larger capacity and number of ports for controlling an entire site and determining bandwidth allocation between apartments. Child routers 704 may be provided throughout the apartment building/complex. Each child router 704 may be tethered to a single apartment unit or may be configured to provide service to multiple apartment units. A split provisioning of the network is provided so that the apartment manager controls master router 702 and the overall network and determines access to child routers, while tenants may be separately provisioned to control their access to the network.

In one example embodiment, each tenant is assigned to one wireless router or a wireless access point that is provided for a group of units. A group may include 2 to 3 units, for example. Each tenant has an individual SSID so that they can manage their Internet access. In this way, 2-3 tenants may manage one access point without realizing they are sharing an access point. Instead of one SSID for the whole site, each tenant receives an SSID and the apartment management company may enable certain features, like broadband access, for individual tenants.

In another embodiment, if a tenant's router fails, the apartment management company can reassign the tenants Internet traffic to nearby routers temporarily while the router is replaced or repaired, so that the tenant does not lose Internet service. Routers typically belong to the apartment complex, not to individual tenants.

Other client sites that may use the architecture discussed in connection with FIG. 7 may include office buildings or campuses including multiple building.

As disclosed herein, master router 702 runs the configuration server for deploying and configuring the system and for remote access. Child routers 704 do not have any native configuration system of their own. During deployment, master router 702 discovers and pushes configurations to child routers 704 and other devices. The master router 702 accepts change requests from both management company and tenants. Depending on the request, master router 702 will either provision itself or issue a command to correct child router 704 for the tenant making the request. Requests may be for increased speed limit changes to wireless name/pass, or changes to LAN ports if provided by management company, for example. If additional charges are necessary for any of these services, they can be assessed by the management company.

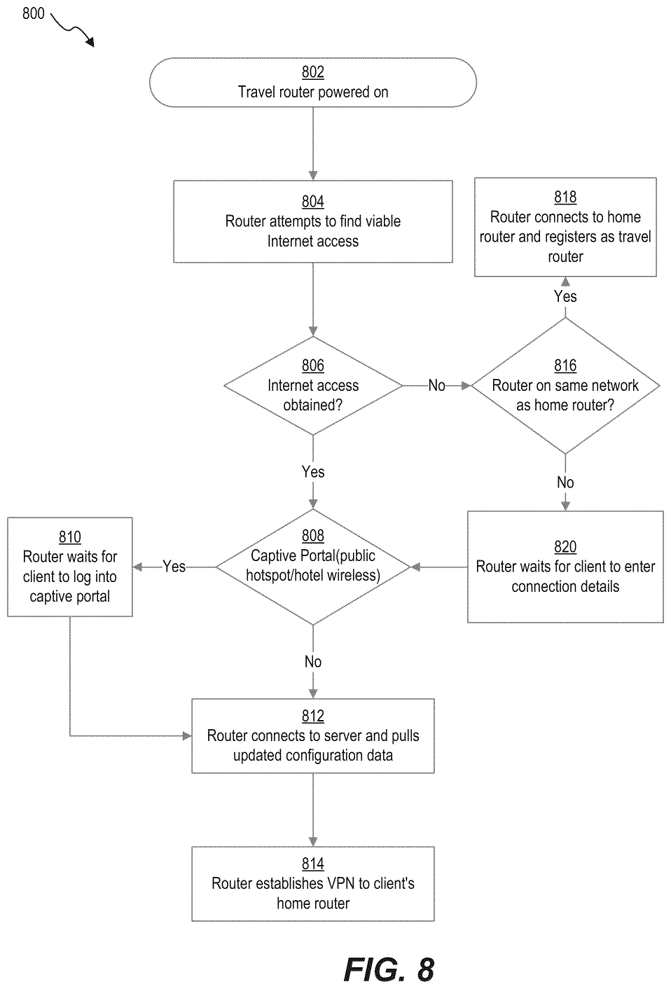

FIG. 8 is a flowchart of a method 800 of simulating a client site network at a remote site using a travel router or a field router.

A travel router is an example of router 102 that may be used in a location other than the client site, such as a hotel or office. Once the travel router is connected to a WAN, it will form a secure VPN to connect back to a client site router or any other server of choice. Establishing a secure VPN provides a user of a travel router access to home based services such as a Roku or cable channel subscriptions like HBO.

A field router is a router that can be tethered to a network manager's laptop or computer. Support personnel may access a client site network through the field router without taking over the network manager's laptop.

In step 802, a travel router is powered on in a location where it will be used, such as a hotel or office.

In step 804, the travel router attempts to connect to the Internet. In an example of step 804, the travel router may attempt to access the Internet using Ethernet, a cellular network or a Wi-Fi connection, for example.

In step 806, it is determined if Internet access is obtained. If yes, method 800 proceeds to step 808.

In step 808, it is determined whether the internet access is a captive portal such as a public hotspot or hotel guest wireless network. If yes, the method proceeds to step 810 where the router waits for the client to log into the public wireless network. If not, the method continues to step 812.

In step 812, the travel router connects to a server such as server 118 of FIG. 1 and downloads updated configuration data pertaining to the client's account/LAN 106.

In step 814, the travel router establishes a VPN to the client's home router 102. In embodiments, the VPN may be an example of VPN 404 of FIG. 4.

Returning to step 806, if the travel router is not able to obtain Internet access, it determines in step 816 whether or not it is connected to the same network as home router 102. If so, in step 818, it connects to the home router and registers as a travel router. If not, method 800 proceeds to step 820.

In step 820, the travel router waits for the client to enter connection details. In an example of step 820, these connection details may include a Wi-Fi connection setting and IP address configurations.

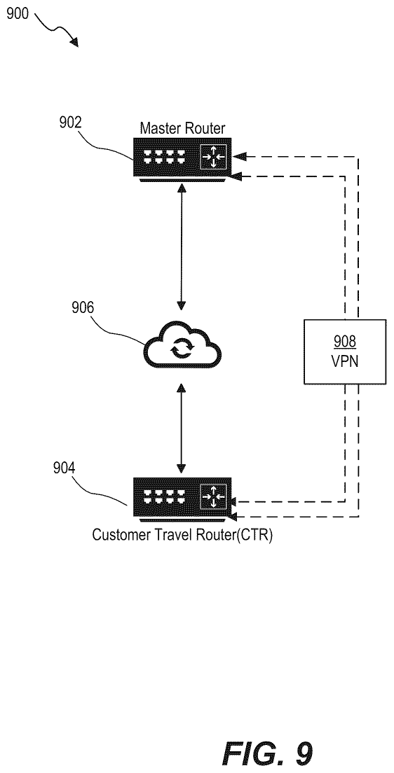

FIG. 9 is a schematic diagram 900 of a secure VPN using a travel or field router using the method of FIG. 8, in embodiments. Travel router 902 connects the master router 902 over an internet connection 906. Master router 902 is an example of router 102 and internet connection 906 is an example of internet 114 of FIG. 1. Once connection is established, VPN 908 is created.

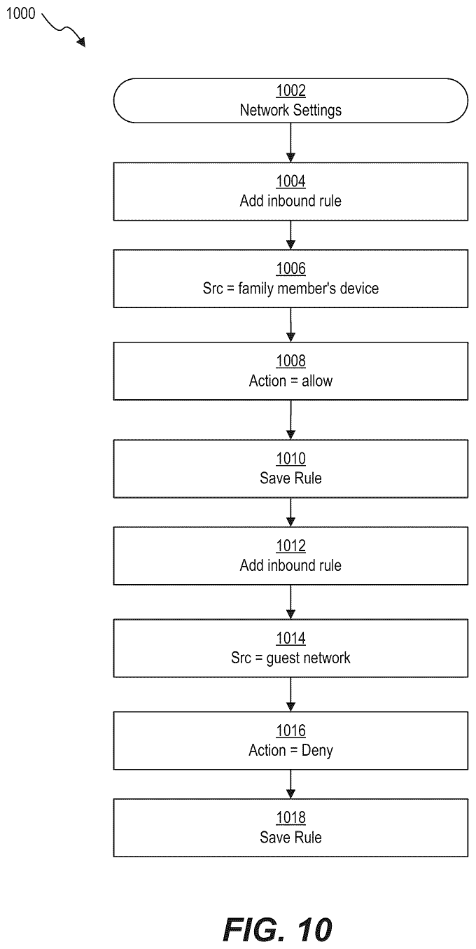

FIG. 10 is a flowchart of a method 1000 of implementing firewall rules using a router with network virtualization and configuration, in embodiments. This is a representative example for purposes of illustrating principles disclosed herein. Other methods of managing the operation of a router may be used.

In an example of the method of FIG. 10, a user is creating a rule that blocks Guest access to a Main Network. The requirements for this rule are A) Block all access from the Guest Network to Main Network devices, B) Allow access from all other networks, and C) Allow a visiting family member's device to connect to the Main Network.

Creating this type of firewall rule typically requires detailed knowledge of IP addresses and the ranges of ranges available for rule creation. Using the wrong value could lock out the internet for one or more devices, or worse kill access to router requiring a factory reset and restore from backup (if one is available). Creating this type of rule may also require a familiarity with networking concepts and rule creation.

As shown in the method of FIG. 10, router 102 provides a user interface where all networks and devices are named with meaningful names. The user interface verifies inputted rules and warns if it detects a potentially fatal rule. In depth knowledge of networking concepts is not required as all input is guided and in understandable terms for the user. The method of FIG. 10 also uses fewer clicks per rule creation. After the rule is created, the system translates the rule into appropriate commands to implement the rule in the network.

The router with network virtualization and configuration as disclosed herein provides a user with minimal networking knowledge people the ability to stand up a complex, enterprise-grade network without the education and experience typically required to complete such a task. A user interface is provided that logically groups networking terms together in an intuitive manner and presents them in a whole solution instead of individual components of a network. The router disclosed herein then translates the logical configuration to the back end to automatically deploy a network.

Changes may be made in the above methods and systems without departing from the scope hereof. It should thus be noted that the matter contained in the above description or shown in the accompanying drawings should be interpreted as illustrative and not in a limiting sense. Herein, and unless otherwise indicated: (a) the adjective “exemplary” means serving as an example, instance, or illustration, and (b) the phrase “in embodiments” is equivalent to the phrase “in certain embodiments,” and does not refer to all embodiments. The following claims are intended to cover all generic and specific features described herein, as well as all statements of the scope of the present method and system, which, as a matter of language, might be said to fall therebetween.

What is claimed is:

1. A method, performed by a router at a client site including a plurality of electronic devices, comprising:
connecting to a wide area network (WAN);
sending a serial number associated with the router to a server over the WAN;
downloading a local area network (LAN) configuration for the plurality of electronic devices at the client site from the server; and
identifying the plurality of devices at the client site and provisioning them according the LAN configuration.

2. The method of claim 1, wherein the LAN configuration is created at the server and associated with the serial number associated with the router.

3. The method of claim 2, wherein the LAN configuration is created using a template stored on the server.

4. The method of claim 1, wherein the plurality of electronic devices include smart televisions and appliances, mobile devices, tablets, laptops, cable boxes, switches, access points, doorbell cameras, thermostats, light bulbs, speaker systems or garage door openers.

5. The method of claim 1, wherein connecting to a WAN at the client site comprises:
connecting the router to a power source; and
connecting the router to a modem at the client site that is connected to the WAN.

6. The method of claim 5, wherein connecting to a WAN further comprises:
assigning an Internet Protocol (IP) address to the router using a Dynamic Host Configuration Protocol (DHCP); or
prompting a user to enter a Static WAN IP address.

7. The method of claim 1, further comprising:
detecting a connection problem between the router and one or more electronic devices of the plurality of electronic devices;
determining whether the router can resolve the connection problem; and
issuing commands to the one or more electronic devices to resolve the connection problem.

8. The method of claim 7, wherein detecting a connection problem includes:
detecting that the one or more electronic devices has physically connected to a port different from the port designated in the LAN configuration; and
changing the LAN configuration to reflect the changed physical connections.

9. The method of claim 7, further comprising:
detecting that a first electronic device has blocked a port designated in the LAN configuration for use by a second electronic device; and
issuing commands to first electronic device to switch to another port.

10. The method of claim 1, wherein connecting to the WAN further comprises implementing a local virtual private network (VPN).

11. The method of claim 10, further comprising:
creating a remote VPN in a remote router;
creating a remote LAN or remote wireless LAN (WLAN) including the remote router;
creating a network bridge between the remote LAN with the LAN at the client site;
assigning a port to a selected VLAN of network at the clients site to the remote router; and
communicating with the plurality of electronic devices using the remote router.

12. The method of claim 11, further comprising terminating the network bridge when:
a set time limit has expired;
a set period of idle time has elapsed; or
a client has revoked access to the LAN at the client site.

13. The method of claim 1, further comprising:
receiving a virtual machine (VM) selection from a user interface;
retrieving an image of the VM; and
provisioning the VM in the router.

14. The method of claim 1, further comprising:
performing a speed test of the WAN connection at a selected interval;
if bandwidth utilization is higher than a high threshold, delaying the speed test; and
if the bandwidth utilization is lower than a low threshold, shorten the selected interval.

15. A computer-implemented method comprising:
providing, for display on a computing device connected to a server, a user interface (UI) comprising a router administrator dashboard;
receiving, via the UI, a user selection of a network configuration for a plurality of electronic devices at a client site;
receiving, via the UI, a serial number of a router to be installed at the client site;
creating, by the server, a detailed network configuration by assigning a plurality of ports of the router to the plurality of electronic devices in the selected network configuration;
receiving, at the server, the serial number from the router when it is connected to the server; and
sending the detailed network configuration to the router for use by the router in creating a network with the plurality of electronic devices at the client site.

16. The method of claim 15, wherein the network configuration is for a local area network (LAN) at the client site and the router is connected to the server by a wide area network (WAN).

17. The method of claim 16, wherein assigning the plurality of ports includes assigning a communication protocol used by each device of the plurality of devices.

18. The method of claim 16, wherein the user selection of a network configuration further comprises selecting a network configuration from a plurality of templates.

19. The method of claim 16, further comprising:
displaying a list of the plurality of electronic devices at the client site with text-based names;
receiving a user selection of connection permissions for each electronic device using the text-based names;
evaluating the selected connection permission for conflicts between electronic devices; and
adding, by the server, the selected connection permissions to the detailed network configuration.

20. The method of claim 16, further comprising:
providing, for display on the computing device connected to a server, a user interface (UI) comprising a network interface dashboard;
receiving, via the UI, a user selection to create a remote virtual private network (VPN) in the computing device;
creating a remote LAN or remote wireless LAN (WLAN) including the router;
creating a network bridge between the remote LAN with the LAN at the client site;
assigning a port in the LAN at the client site to the computing device; and
communicating with the plurality of electronic devices using the computing device.

21. A system comprising:
a master router performing the method of claim 1; and
one or more child routers provisioned with configuration information by the master router, wherein the configuration information includes a service set identifier (SSID).

22. A method, performed by a remote router registered with a router at a client site including a plurality of electronic devices, the method comprising:
connecting to a wide area network (WAN);
downloading a local area network (LAN) configuration for the plurality of electronic devices at the client site from a server; and
establishing a Virtual Private Network (VPN) to the router at the client site.
